(19) United States
(12) Patent Application Publication
(10) Pub. No.: US 2019/0198257 A1
(43) Pub. Date: Jun. 27, 2019

(54) DYE-SENSITIZED SOLAR CELL

(71) Applicant: TAIYO YUDEN CO., LTD., Tokyo (JP)

(72) Inventors: Hidenori SOMEI, Takasaki-shi (JP); Takeyuki FUKUSHIMA, Takasaki-shi (JP); Chengli HE, Takasaki-shi (JP)

(21) Appl. No.: 16/228,044

(22) Filed: Dec. 20, 2018

(30) Foreign Application Priority Data
Dec. 27, 2017 (JP) 2017-251993

(51) Int. Cl. H01G 9/20; C09B 57/10

(52) U.S. Cl. CPC H01G 9/2031; C09B 57/10; H01G 9/2059

(57) ABSTRACT

A dye-sensitized solar cell 10 includes: an electrode 11; a counter electrode 12 disposed facing the electrode 11; an electrolyte layer 16 sandwiched between the electrode 11 and the counter electrode 12; and a power generation layer 15 provided on a surface of a counter electrode 12 side of the electrode 11 and formed of oxide semiconductor particles 13 supporting a sensitizing dye 14, wherein the electrolyte layer 16 includes a matrix, with an electrolyte dispersed therein, of a polymer compound existing in a solid state at ordinary temperature and pressure.

### TECHNICAL FIELD

The present invention relates to a dye-sensitized solar cell.

### BACKGROUND ART

In recent years, a crystalline silicon solar cell may be mentioned as one of solar cell modules in widespread use. The crystalline silicon solar cell is characterized by having a higher photoelectric conversion efficiency when irradiated with sunlight, and the crystalline silicon solar cell with a photoelectric conversion efficiency of 20% range is recently available in a market. The crystalline silicon solar cell is used in various types ranging from a type placed on rooftop of a house to a large-scale power generation plant like mega solar.

On the other hand, an organic solar cell is under development. It is known that the organic solar cell generates a larger power generation amount per unit area as compared with a conventional amorphous silicon solar cell. For example, Patent Literature 1 discloses a dye-sensitized solar cell with a gelled electrolyte excellent in heat resistance, in which it is possible to suppress gel dissolution even at high temperature.

Further, Patent Literature 2 discloses a method of manufacturing a dye-sensitized solar cell including a solid electrolyte layer instead of a liquid electrolyte.

Still further, Patent Literature 3 discloses a solar cell containing an amino compound having a benzoic acid group in an electron transfer layer. It is disclosed that it is possible to achieve good photoelectric conversion property even at low illuminance according to this solar cell.

Since the dye-sensitized solar cell of Patent Literature 1 contains excessively in the gelled electrolyte a solvent in a liquid state at ordinary temperature and pressure, ionic conduction of the electrolyte is higher and then a power generation amount is highly generated when irradiated with light. However, a solvent such as propylene carbonate or acetonitrile is excessively contained in the gelled electrolyte of Patent Literature 1, resulting in that reliability may be lowered in some cases. That is, a high-boiling point solvent such as propylene carbonate has a property of dissolving organic compounds with polarity, and particularly in a case of keeping high temperature, even a dye adsorbed in a power generation layer is dissolved resulting in that power generation performance may be remarkably lowered in some cases. In addition, a low-boiling point solvent such as acetonitrile may dissolve the dye adsorbed in the power generation layer, and the dye is volatilized at high temperature to raise internal pressure of the cell resulting in that the cell may be destroyed. Therefore, in Patent Literature 1, in order to avoid a decrease in performance due to solvent, the gelled electrolyte is obtained through a method of mixing monomer and polymerization initiator in an electrolytic solution and polymerizing monomer in the electrolytic solution. However, since the electrolyte itself reacts when polymerization is performed in the electrolytic solution, a photoelectric conversion efficiency of Example in Patent Literature 1 using the gelled electrolyte is lower than that of Comparative Example.

On the other hand, the solid electrolyte of Patent Literature 2 does not contain a solvent therein and includes an electrolyte only. The solid electrolyte is obtained through a method of filling the cell with an electrolyte converted in advance to a liquid state by heating it to melting temperature. The electrolyte is solidified when returned to room temperature. The electrolyte is crystallized when solidified alone. Then, the electrolyte is not dissociated into ions, and the number of electron carriers and hole carriers in the cell decreases, resulting in that power generation performance is greatly lowered. Therefore, although the reliability is improved, there is a problem that the cell performance in a steady state is lowered.

In the disclosure of Patent Literature 3, an amino compound is newly synthesized resulting in that it leads to concern about increase in cost of the solar cell.

Up to now, since an electrolyte layer converted to a solid state leads to concern about a decrease in cell performance by inhibition of electrolytic dissociation, approaches to devising additives have been taken for countermeasures. However, the inventors of the present invention have found that electrolytic dissociation can be promoted while allowing solidification of the electrolyte layer by replacing an excessive organic solvent in the electrolyte with a specific compound. Furthermore, the inventors have found that power generation property is good while suppressing elution of a dye adsorbed in a power generation layer into the electrolyte layer by solidification of the electrolyte layer. Accordingly, the present invention has been accomplished.

### CITATION LIST

### Patent Literature

[Patent Literature 1] Japanese Unexamined Patent Application Publication No. 2005-149821
[Patent Literature 2] Japanese Unexamined Patent Application Publication No. 2017-147389
[Patent Literature 3] Japanese Unexamined Patent Application Publication No. 2017-98372

### SUMMARY OF INVENTION

### Technical Problem

The present invention has been made in view of the above circumstances, and an object thereof is to provide a dye-sensitized solar cell with high cell performance and high temporal reliability at high temperature.

### Solution to Problem

In accordance with an aspect of the present invention, a dye-sensitized solar cell includes: an electrode; a counter electrode disposed facing the electrode; an electrolyte layer sandwiched between the electrode and the counter electrode; and a power generation layer provided on a surface of a counter electrode side of the electrode and formed of oxide semiconductor particles supporting a sensitizing dye, wherein the electrolyte layer includes a matrix, with an electrolyte dispersed therein, of a polymer compound existing in a solid state at ordinary temperature and pressure.

The polymer compound may have in a main chain a constitutional unit including at least one selected from an oxygen atom, a sulfur atom, a nitrogen atom, a phosphorus atom, a fluorine atom and a silicon atom.

The polymer compound may be at least one selected from polyethylene oxide, polyethylene glycol, polyvinyl alcohol and polyvinylpyrrolidone.

The polymer compound may have a substituent.

The substituent may be at least one selected from a hydroxyl group, a carboxyl group, a carbonyl group, an ester group, an ether group, an amino group, an alkylamino group and an amide group.

The polymer compound may have a weight-average molecular weight of more than or equal to 2,000.

The dye-sensitized solar cell may further include a reverse electron transfer preventing layer between the electrode and the power generation layer, the reverse electron transfer preventing layer having a film structure denser than the power generation layer.

The reverse electron transfer preventing layer may have a thickness of more than or equal to 1 nm and less than or equal to 1 μm.

The electrolyte may include triiodide ions I₃⁻ and iodide ions I⁻, a concentration of the iodide ions I⁻ being more than or equal to 1 mol/L and less than or equal to 10 mol/L, and moreover, more than or equal to 2 million times and less than or equal to 200 million times with respect to a concentration of the triiodide ions I₃⁻.

The dye-sensitized solar cell may be applicable for use in indoor.

### Advantageous Effects of Invention

According to the present invention, it is possible to provide a dye-sensitized solar cell with high cell performance and high temporal reliability at high temperature.

### BRIEF DESCRIPTION OF DRAWINGS

FIG. 1 is a schematic sectional view showing a dye-sensitized solar cell according to an embodiment of the present invention.

FIG. 2 is a schematic cross-sectional view showing a dye-sensitized solar cell according to another embodiment of the present invention.

FIG. 3 is a graph showing a temporal change in electric energy at 80° C. in Examples and Comparative Examples.

### DESCRIPTION OF EMBODIMENTS

Hereinafter, dye-sensitized solar cells in accordance with Embodiments of the present invention are described with reference to the accompanying figures.

[Dye-Sensitized Solar Cell]

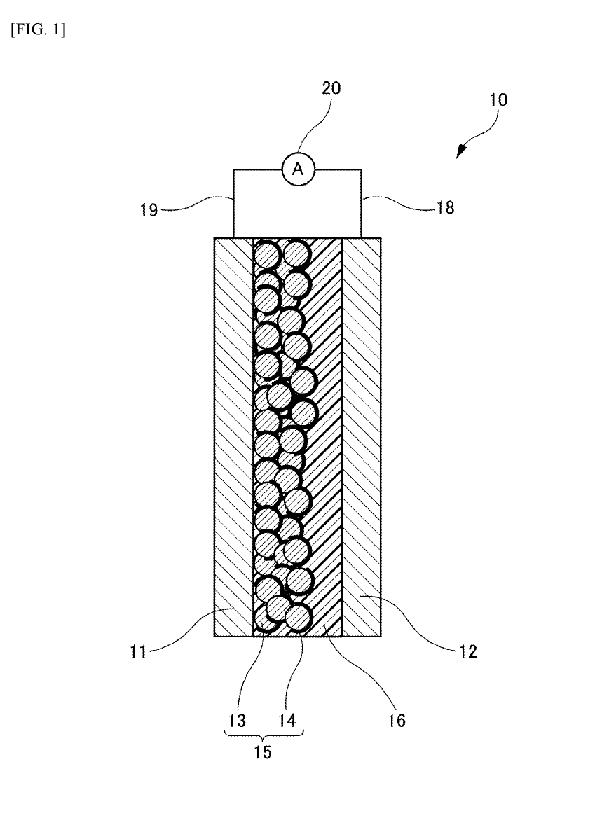

As shown in FIG. 1, a dye-sensitized solar cell 10 of an Embodiment includes an electrode 11, a counter electrode 12 disposed facing the electrode 11, an electrolyte layer 16 sandwiched between the electrode 11 and the counter electrode 12, and a power generation layer 15 provided on a surface of a counter electrode 12 side of the electrode 11 and formed of oxide semiconductor particles 13 supporting a sensitizing dye 14, wherein the electrolyte layer 16 includes a matrix, with an electrolyte dispersed therein, of a polymer compound existing in a solid state at ordinary temperature and pressure. A lead wire 19 is connected to the electrode 11, and a lead wire 18 is connected to the counter electrode 12. The lead wires 18, 19 are connected to an ammeter 20, respectively. Hereinafter, such elements of the dye-sensitized solar cell 10 are described.

(Electrode)

The electrode 11 functions as a negative electrode of the dye-sensitized solar cell 10. With respect to materials for the electrode 11, any material for negative electrodes of known dye-sensitized solar cells may be referred. For example, from the viewpoint of emphasis on high conductivity and translucency, it is possible to form the electrode 11 on a surface of a translucent substrate such as a glass substrate with zinc oxide, indium-tin complex oxide (ITO), a laminate including an indium-tin complex oxide layer and a silver layer, antimony-doped tin oxide, fluorine-doped tin oxide (FTO) or the like. Among others, ITO and FTO are preferable for reason of particularly high conductivity and translucency.

A thickness of the electrode 11 may be optionally determined. For example, the thickness of more than or equal to 0.3 μm and less than or equal to 10 μm is preferable. A surface resistance of the electrode 11 is preferably about less than or equal to 200 Ω/sq., for example. In a dye-sensitized solar cell to be used under sunlight, the surface resistance of a negative electrode is mostly about 10 Ω/sq. However, a dye-sensitized solar cell for indoor use is expected to be used under a fluorescent lamp or the like having lower illuminance than sunlight, and it is less affected by a resistance component contained therein because of a small photoelectron quantity (photocurrent value). So, the surface resistance of the electrode 11 may be, for example, more than or equal to 20 Ω/sq. and less than or equal to 200 Ω/sq. rather than an extremely low resistance.

(Counter Electrode)

The counter electrode 12 functions as a positive electrode of the dye sensitized solar cell 10. Materials for the counter electrode 12 are not particularly limited, and materials as with the electrode 11 may be employed. In addition, the counter electrode 12 may include a material performing catalysis to give electrons to electrolyte oxidant. Examples of the counter electrode 12 may include a metal such as platinum, gold, silver, copper, aluminum, rhodium, indium or ruthenium; graphite; carbon supporting platinum; and a metal oxide such as indium-tin complex oxide (ITO), antimony-doped tin oxide or fluorine-doped tin oxide (FTO). Further, an organic semiconductor such as poly(3,4-ethylenedioxythiophene) (PEDOT) or polythiophene may be also included in examples. Among others, platinum and graphite are particularly preferable.

(Electrolyte Layer)

The dye-sensitized solar cell 10 of the Embodiment includes the electrolyte layer 16 sandwiched between the electrode 11 and the counter electrode 12. The electrolyte layer 16 includes a matrix, with an electrolyte dispersed therein, of a polymer compound existing in a solid state at ordinary temperature and pressure. Here, the ordinary temperature means a temperature in a range of 20° C.±15° C. (namely higher than or equal to 5° C. and lower than or equal to 35° C.). In the Embodiment, the polymer compound may be solid at any temperature in the range of 20° C.±15° C. In addition, the ordinary pressure means a pressure equal to atmospheric pressure.

Matrix

The matrix included in the electrolyte layer 16 of the dye-sensitized solar cell 10 of the Embodiment is made of the polymer compound existing in a solid state at ordinary temperature and pressure. In an electrolyte layer of a conventional dye-sensitized solar cell, a solvent was excessively used as a medium in which an electrolyte was dispersed. By contrast thereto, in the Embodiment, the polymer compound existing in a solid state is used in place of such excessive solvent. A content of the polymer compound existing in a solid state as the matrix is more than or equal to 1 wt. % and less than or equal to 50 wt. % in the electrolyte layer 16. The electrolyte layer 16 of the Embodiment does not excessively contain a liquid material (including a solvent) as a medium for charge-transfer. However, when an additive as described later is a liquid, such liquid additive may be contained within a range of added amount. In addition, the electrolyte layer 16 is formed, as described later, using a solvent in manufacturing process thereof. It is regardless of whether such solvent remains. It is possibly that the electrolyte layer 16 contains a small amount of moisture in the air during manufacturing process, in such cases, its concentration is preferably less than or equal to about 100 ppm (mass basis).

It is preferable that the polymer compound existing in a solid state at ordinary temperature and pressure has in a main chain a constituent unit including at least one selected from an oxygen atom, a sulfur atom, a nitrogen atom, a phosphorus atom, a fluorine atom and a silicon atom. Specifically, examples of the polymer compound existing in a solid state at ordinary temperature and pressure may include polyethylene glycol (molecular weight: more than or equal to 2,000 and less than or equal to 20,000), polyethylene oxide (molecular weight: more than or equal to 20,000 and less than or equal to 10,000,000), polyvinylpyrrolidone (molecular weight: more than or equal to 10,000 and less than or equal to 1,000,000) and polyvinyl alcohol (molecular weight: more than or equal to 10,000 and less than or equal to 100,000). From the viewpoint of improvement of reliability over time at high temperature, polyethylene glycol, polyvinylpyrrolidone and polyvinyl alcohol are preferable, and polyethylene oxide is more preferable.

The polymer compound may have a substituent. The substituent may be preferably at least one selected from a hydroxyl group, a carboxyl group, a carbonyl group, an ester group, an ether group, an amino group, an alkylamino group and an amide group. From the viewpoint of improvement of photoelectric conversion efficiency and reliability over time at high temperature, the carbonyl group is preferable, the hydroxyl group is more preferable, and the ether group is much more preferable.

A weight-average molecular weight of the polymer compound is preferably more than or equal to 2,000 and less than or equal to 10,000,000, and more preferably more than or equal to 20,000 and less than or equal to 2,000,000. In particular, when the weight-average molecular weight is more than or equal to 20,000, the dye is not dissolved in the matrix even at high temperature, for example, higher than equal to 100° C. so that cell performance may be improved. In addition, when the weight-average molecular weight is less than or equal to 2,000,000, the electrolyte may be well dispersed in the matrix so that the photoelectric conversion efficiency may be improved. Here, in the description, the weight-average molecular weight of the polymer compound is defined by a weight-average molecular weight in polystyrene equivalent obtained with Gel Permeation Chromatography (GPC) apparatus (HLC-8120 manufactured by Tosoh Corporation) and column (TSKgel SuperHZM-H, TSKgel SuperHZ4000 and TSKgel SuperHZ200 manufactured by Tosoh Corporation).

By using the polymer compound existing in a solid state at ordinary temperature and pressure, it is possible to solidify the electrolyte while promoting dissociation of the electrolyte, and also to suppress elution of the sensitizing dye 14 adsorbed in the power generation layer 15 into the electrolyte.

Electrolyte

As the electrolyte, known one in use for a dye-sensitized solar cell as usual may be employed. Examples of the electrolyte may include I⁻/I₃⁻ series, Br⁻/Br₃⁻ series, Fe²⁺/Fe³⁺ series, quinone/hydroquinone series and the like. Among others, the I⁻/I₃⁻ series is particularly preferable. Tetraalkylammonium iodide such as tetrapropylammonium iodide; asymmetric alkylammonium iodide such as methyltripropylammonium iodide or diethyldibutylammonium iodide; or quaternary ammonium iodide compound such as pyridinium iodide are preferably employed in combination with iodine. These compounds are ionized in the polymer compound to generate ammonium ions with an alkyl group. When the electrolyte layer 16 contains ammonium ions with an alkyl group, it is possible to achieve a relatively high voltage value even under low illuminance.

Further, it is preferable that at least one of atoms included in the alkyl group is substituted with a nitrogen atom, an oxygen atom, a halogen atom or the like. When an ammonium ion contains a plurality of alkyl groups, it is preferable that a part of the plurality of alkyl groups is substituted with an aralkyl group, an alkenyl group or an alkynyl group. An iodine compound to be generated by ionization of these ammonium ions exists as ions in the polymer compound existing in a solid state.

Examples of the iodine compound may include 1,2-dimethyl-3-propylimidazolium iodide, 1,3-dimethylimidazolium iodide (DMII), butylmethylimidazolium iodide (BMII), quaternary ammonium iodide salt compound such as pyridinium iodide or the like.

Here, a concentration of I⁻ contained in the electrolyte layer 16 is preferably more than equal to 1 mol/L and less than or equal to 10 mol/L. This concentration is significantly higher than a concentration of I⁻ in an electrolyte layer of a dye-sensitized solar cell as known. In addition, the concentration of I⁻ in the electrolyte layer 16 is more than or equal to 2 million times and less than or equal to 200 million times with respect to a concentration of I₃⁻. This concentration ratio is significantly higher than a concentration ratio in a dye-sensitized solar cell as known. The concentrations of I₃⁻ and I⁻ are determined by an abundance ratio of iodine I₂ and the above-mentioned iodine compound which generates iodide ions I⁻. Although a method of forming the electrolyte layer 16 is described later in detail, the electrolyte layer 16 is formed by applying a solid electrolyte precursor (coating composition) containing a solvent and removing excessive solvent. In the solid electrolyte precursor, I⁻ and I₂ react with I⁻+I₂→I₃⁻ to generate I₃⁻ ions. Therefore, in order to adjust the concentration ratio of I⁻ to I₃⁻, such chemical reaction is progressed by adding a very small amount of I₂ to the iodine compound to generate a very small amount of I₃⁻. The concentrations of I₃⁻ and I⁻ in the electrolyte layer 16 are measured by Nuclear Magnetic Resonance Spectrometry or the like.

By setting up the concentration of I⁻ in the electrolyte layer 16 as more than or equal to 1 mol/L and less than or equal to 10 mol/L, it is expected to achieve the effect of accelerating electron transfer from I⁻ to the sensitizing dye 14. By setting up the concentration of I⁻ in the electrolyte layer 16 as more than or equal to 2 million and less than or equal to 200 million times with respect to I₃⁻, it is expected to achieve the effect of suppressing electron transfer from the electrode 11, the oxide semiconductor particle 13 and the sensitizing dye 14 to I₃⁻. As a result of these effects, it is expected that a power generation amount and a current value are increased, particularly under a low illuminance environment. In addition, since the concentration of I⁻ in the electrolyte layer 16 is high, a contact probability of I₃⁻ to the electrode 11, the oxide semiconductor particle 13 and the sensitizing dye 14 is decreased, and then it is expected that the power generation amount further is increased.

In a method of forming the electrolyte layer 16, first, the polymer compound existing in a solid state and the electrolyte are dissolved in a solvent and uniformly mixed to prepare a solid electrolyte precursor. Next, this solid electrolyte precursor is applied on the power generation layer 15 of the negative electrode (the electrode 11). Finally, excessive solvent is removed by heating or heat-treating under reduced pressure or vacuum.

Additive

The electrolyte layer 16 may contain an additive. Examples of the additive include pyridine, pyridine derivatives, imidazole, imidazole derivatives, and borate tri-o-cresyl ester ((CH₃C₆H₄O)₃B). A content of the additive in the electrolyte layer 16 is preferably more than or equal 0.1 wt. % and less than 20 wt. %. More preferably, it is more than or equal to 1 wt. % and less than 10 wt. %.

(Power Generation Layer)

The power generation layer 15 is provided on a surface of a counter electrode 12 side of the electrode 11 and is formed of the oxide semiconductor particles 13 supporting the sensitizing dye 14.

Sensitizing Dye

As materials for the sensitizing dye 14, for example, various dyes such as a metal complex dye and an organic dye may be employed. Examples of the metal complex dye may include a transition metal complex such as a ruthenium-cis-diaqua-bipyridyl complex, a ruthenium-tris complex, a ruthenium-bis complex, an osmium-tris complex or an osmium-bis complex; zinc-tetra(4-carboxyphenyl) porphyrin; an iron-hexacyanide complex; and phthalocyanine. Examples of the organic dye may include a 9-phenylxanthene dye, a coumarin dye, an acridine dye, a triphenylmethane dye, a tetraphenylmethane dye, a quinone dye, an azo dye, an indigo dye, a cyanine dye, a merocyanine dye, a xanthene dye and a carbazole compound dye.

A method of applying the sensitizing dye 14 is not particularly limited. For example, it is acceptable to employ a method in which a solution containing the sensitizing dye 14 is applied on a layer composed of the oxide semiconductor particles 13 and then dried. Alternatively, it is also acceptable to employ a method in which the electrode 11 provided with the oxide semiconductor particles 13 is immersed in a solution containing the sensitizing dye 14 and then dried. Examples of a solvent of the solution containing the sensitizing dye 14 include water, alcohol, acetonitrile, toluene and dimethylformamide.

Oxide Semiconductor Particles

A size of individual particle of the oxide semiconductor particles 13 included in the power generation layer 15 may be preferably about more than or equal to 5 nm and less than or equal to 1 μm in diameter.

Examples of the oxide semiconductor particles 13 included in the power generation layer 15 may include an oxide of metal such as Cd, Zn, In, Pb, Mo, W, Sb, Bi, Cu, Hg, Ti, Ag, Mn, Fe, V, Sn, Zr, Sr, Ga, Si, Cr or Nb, and perovskite oxide such as SrTiO₃ or CaTiO₃. One of these oxides may be employed, or a complex containing two or more of these oxides may be employed. Among others, TiO₂ may be preferable, because it is chemically stable and has excellent photoelectric conversion property.

The oxide semiconductor particles 13 play a role of transferring electrons to the electrode 11 from the sensitizing dye 14 having absorbed light in a state supported on a surface of the particles. And also, the oxide semiconductor particles 13 have the effect of holding the electrolyte in minute voids existing near the particles.

A thickness of the power generation layer 15 may be preferably more than or equal to 100 nm and less than or equal to 40 μm. By setting up the thickness as more than or equal to 100 nm, it is possible to well suppress contacts of I₃⁻ with the electrode 11. Further, by setting up the thickness as less than or equal to 40 μm, it is possible to well transfer electrons to the electrode 11. The power generation layer 15 may be manufactured by, for example, a method of applying a paste containing the oxide semiconductor particles 13, followed by drying and heating it.

(Reverse Electron Transfer Preventing Layer)

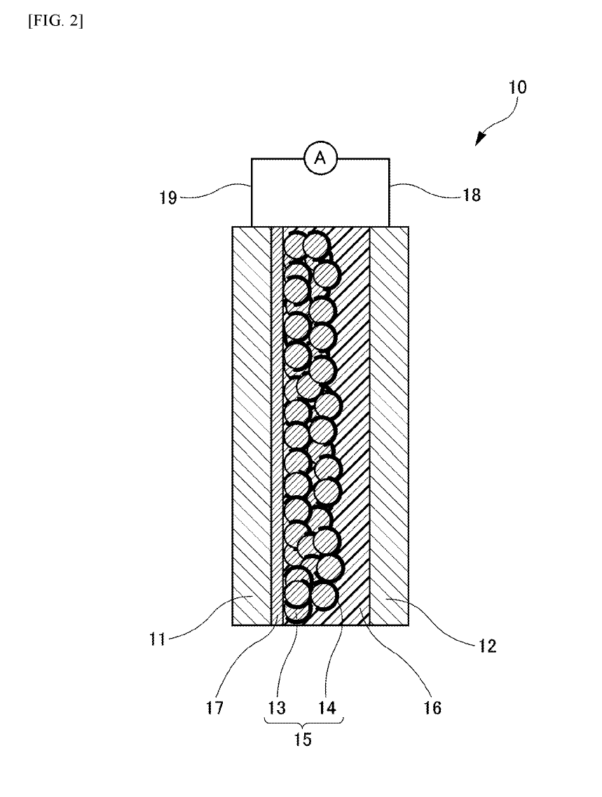

As shown in FIG. 2, the dye-sensitized solar cell 10 of the Embodiment may further include a reverse electron transfer preventing layer 17 between the electrode 11 and the power generation layer 15. The reverse electron transfer preventing layer 17 is composed of oxide semiconductor particles and has a film structure denser than the power generating layer 15. As the oxide semiconductor particles in use for the reverse electron transfer preventing layer 17, materials as with the oxide semiconductor particles 13 of the power generating layer 15 may be employed. The oxide semiconductor particles of the reverse electron transfer preventing layer 17 and the oxide semiconductor particles 13 of the power generating layer 15 may be made of an identical material or different materials for each other. In a case of having the reverse electron transfer preventing layer 17, the sensitizing dye 14 may be preferably adsorbed on at least a part of a surface of the reverse electron transfer preventing layer 17. Alternatively, the sensitizing dye 14 and the oxide semiconductor particles of the reverse electron transfer preventing layer 17 may exist in a mingled manner.

The presence of the reverse electron transfer preventing layer 17 in a form of a dense film structure may be confirmed under an electron microscopic observation accompanying a chemical composition analysis of a cross-section structure. Specifically, as approaching the surface of the electrode 11 from the counter electrode 12, it is observable that the oxide semiconductor particles 13 having a relatively large particle size are accumulated with voids opened in part, and as further approaching the surface of the electrode 11, it is observable that oxide semiconductor particles having a relatively small particle size are densely accumulated in a film structure. This film structure may be identified as the reverse electron transfer preventing layer 17.

A size of individual particle of the oxide semiconductor particles included in the reverse electron transfer preventing layer 17 may be preferably about more than or equal to 0.1 nm and less than or equal to 5 nm in diameter. It is inferred that the reverse electron transfer preventing layer 17 has a different effect from the oxide semiconductor particles 13 of the power generation layer 15. It is considered that the reverse electron transfer preventing layer 17 plays a role of suppressing contacts of I₃⁻ with the electrode 11.

A thickness of the reverse electron transfer preventing layer 17 may be preferably more than or equal to 1 nm and less than or equal to 1 μm. By setting up the thickness as more than or equal to 1 nm, it is possible to well suppress contacts of I₃⁻ with the electrode 11. Further, by setting up the thickness as 1 less than or equal to μm, it is possible to well transfer electrons to the electrode 11.

Method of Manufacturing Reverse Electron Transfer Preventing Layer

As a method of manufacturing the reverse electron transfer preventing layer 17 in a dense film structure, it is acceptable to employ a sol-gel method with use of an alkoxide containing a metal included in a target oxide. The method is not limited to this manufacturing method, and any conventional technique related to a method of forming a film comprising fine particles may be appropriately referred.

(Other Components)

In addition to the above-mentioned components, the dye-sensitized solar cell 10 according to the Embodiment of the present invention may have a sealing layer. The sealing layer may be prepared by applying a resin adhesive such as an acrylic resin adhesive or an epoxy resin adhesive, which becomes hardened by heat, light, electron beam or the like, to a portion to be sealed, followed by hardening it. As a spacer, a polymer film such as a polyester film or a polyethylene film with a constant thickness of more than or equal to 5 μm and less than or equal to 100 μm may be employed.

Although the dye-sensitized solar cell 10 according to the Embodiment of the present invention is applicable to any apparatus for use in both outdoor and indoor, it is particularly suitable to use it in a low illuminance environment and then it is preferable to install it in an electronic apparatus or the like for use in indoor. For example, in the Embodiment of the present invention, it is possible to easily obtain the dye-sensitized solar cell 10 with a power generation amount of more than or equal to 3.5×10⁻⁶ W/cm² and a current value of more than or equal to 8.2×10⁻⁶ A/cm² in a low illuminance environment at 200 lux in illuminance.

Since the dye-sensitized solar cell 10 according to the Embodiment of the present invention is excellent in usage in a low illuminance environment, it can be installed in an electronic component for use. Examples of the electronic component may include a wireless sensor or a beacon in which the dye-sensitized solar cell 10 according to the Embodiment of the present invention is incorporated as a main power source or an auxiliary power source. According to the Embodiment of the present invention, it is possible to provide the dye-sensitized solar cell 10 with high cell performance and high temporal reliability at high temperature through suppressing elution of the sensitizing dye 14 adsorbed in the power generation layer 15 into the electrolyte 11. In addition, since synthesis of a novel compound is not needed, it is possible to prevent an increase in cost.

### EXAMPLES

Hereinafter, the above Embodiments are described more specifically with reference to Examples, but the scope of the present invention is not limited to Examples as shown below.

[Example 1]

A dye-sensitized solar cell of Example 1, in accordance with the dye-sensitized solar cell 10 shown in FIG. 2, was produced as below. The reverse electron transfer preventing layer 17 was formed by coating a surface of FTO (corresponding to a negative electrode or the electrode 11) of a glass/FTO substrate with an alcohol solution prepared from titanium alkoxide and heating it at 550° C. Next, a titanium oxide paste (trade name “PST-30 NRD” manufactured by JGC Catalysts and Chemicals Ltd.) was printed on the reverse electron transfer preventing layer 17 in an area of 1 cm² by a screen-printing method. The coated titanium oxide paste was heated together with the glass/FTO substrate at 550° C. for about 30 minutes so as to remove organic component contained in the titanium oxide paste and form a layer of titanium oxide particles. The layer of titanium oxide particles thus obtained was immersed into a solution prepared by dissolving the sensitizing dye 14 (ruthenium complex dye: CYC-B11(K), concentration: 0.2 mM, manufactured by Tanaka Kikinzoku Kogyo K. K.) in an organic solvent mixed with acetonitrile and t-butanol at a volume ratio of 1:1. And then, the layer of titanium oxide particles was allowed to stand at 50° C. for 4 hours so that the sensitizing dye 14 was absorbed onto the titanium oxide particles (corresponding to the oxide semiconductor particles 13), thereby the power generation layer 15 was formed. Separately, a positive electrode (corresponding to the counter electrode 12) was prepared by sputtering platinum onto a surface of FTO of another glass/FTO substrate.

Preparation of Solid Electrolyte Precursor

A solid electrolyte precursor was prepared by uniformly mixing 1,3-dimethylimidazolium iodide (DMII), iodine I₂ and polyethylene oxide (Alfa Aesar (registered trademark) manufactured by Johnson Matthey Japan G. K, weight-average molecular weight: 1,000,000) in acetonitrile so as to be 8.19 wt. % of 1,3-dimethylimidazolium iodide (DMII), 4.2×10⁻⁷ wt. % of iodine I₂ and 4.38 wt. % of polyethylene oxide. Acetonitrile corresponded to 87.4 wt. %.

20 μL of the solid electrolyte precursor was dropped on the power generation layer 15 of the negative electrode (the electrode 11), and the power generation layer 15 was heated to 100° C. and maintained for 5 minutes to volatilize excessive acetonitrile contained in the solid electrolyte precursor, thereby the electrolyte layer 16 was formed. At the time of heating, a decompression step may be combined.

A sealing material was applied in a frame shape on platinum of the positive electrode (the counter electrode 12) and a predetermined process was carried out for preparation of sealing. Incidentally, the sealing material may be also applied on a side of the power generation layer 15 on the glass/FTO substrate (the electrode 11) as necessary. After the power generation layer 15 was brought back to room temperature, the power generation layer 15 of the negative electrode (the electrode 11) was arranged facing platinum of the positive electrode (the counter electrode 12), and then the dye-sensitized solar cell 10 was obtained in a small size by sealing the positive electrode and the negative electrode under reduced pressure or vacuum with the aid of the sealing material.

[Example 2]

A dye-sensitized solar cell was produced in the same manner as Example 1 except that polyvinylpyrrolidone K90 (weight-average molecular weight: 360,000, manufactured by FUJIFILM Wako Pure Chemical Corporation) was used as a polymer compound to be added to a solid electrolyte precursor.

Preparation of Solid Electrolyte Precursor

A solid electrolyte precursor was prepared by uniformly mixing 1,3-dimethylimidazolium iodide (DMII), iodine I₂ and polyvinylpyrrolidone in acetonitrile so as to be 8.19 wt. % of 1,3-dimethylimidazolium iodide (DMII), 4.2×10⁻⁷ wt. % of iodine I₂ and 4.38 wt. % of polyvinylpyrrolidone. Acetonitrile corresponded to 87.4 wt. %.

[Example 3]

A dye-sensitized solar cell was produced in the same manner as Example 1 except that polyvinyl alcohol (degree of polymerization: 2,000, manufactured by FUJIFILM Wako Pure Chemical Corporation) was used as a polymer compound to be added to a solid electrolyte precursor.

Preparation of Solid Electrolyte Precursor

A solid electrolyte precursor was prepared by uniformly mixing 1,3-dimethylimidazolium iodide (DMII), iodine I₂ and polyvinyl alcohol in a mixed solvent of acetonitrile and water so as to be 8.19 wt. % of 1,3-dimethylimidazolium iodide (DMII), 4.2×10⁻⁷ wt. % of iodine I₂ and 4.38 wt. % of polyvinyl alcohol. The mixed solvent of acetonitrile and water corresponded to 87.4 wt. %.

[Example 4]

A dye-sensitized solar cell was produced in the same manner as Example 1 except that polyethylene glycol (weight-average molecular weight: 2,000, manufactured by FUJIFILM Wako Pure Chemical Corporation) was used as a polymer compound to be added to a solid electrolyte precursor.

Preparation of Solid Electrolyte Precursor

A solid electrolyte precursor was prepared by uniformly mixing 1,3-dimethylimidazolium iodide (DMII), iodine I₂ and polyethylene glycol 2,000 in acetonitrile so as to be 8.19 wt. % of 1,3-dimethylimidazolium iodide (DMII), 4.2×10⁻⁷ wt. % of iodine I₂ and 4.38 wt. % of polyethylene glycol 2,000. Acetonitrile corresponded to 87.4 wt. %.

[Example 5]

A dye-sensitized solar cell was produced in the same manner as Example 1 except that polyethylene glycol (weight-average molecular weight: 20,000, manufactured by FUJIFILM Wako Pure Chemical Corporation) was used as a polymer compound to be added to a solid electrolyte precursor.

Preparation of Solid Electrolyte Precursor A solid electrolyte precursor was prepared by uniformly mixing 1,3-dimethylimidazolium iodide (DMII), iodine I₂ and polyethylene glycol 20,000 in acetonitrile so as to be 8.19 wt. % of 1,3-dimethylimidazolium iodide (DMII), 4.2×10⁻⁷ wt. % of iodine I₂ and 4.38 wt. % of polyethylene glycol 20,000. Acetonitrile corresponded to 87.4 wt. %.

[Example 6]

A dye-sensitized solar cell was produced in the same manner as Example 1 except that the reverse electron transfer preventing layer 17 was not formed in accordance with the dye-sensitized solar cell 10 shown in FIG. 1. A titanium oxide paste (trade name “PST-30 NRD”, manufactured by JGC Catalysts and Chemicals Ltd.) was printed on a surface of FTO (corresponding to a negative electrode or the electrode 11) of a glass/FTO substrate in an area of 1 cm² by a screen-printing method without forming the reverse electron transfer preventing layer 17.

[Comparative Example 1]

A dye-sensitized solar cell was produced in the same manner as Example 1 except that polyethylene glycol (weight-average molecular weight: 200, manufactured by FUJIFILM Wako Pure Chemical Corporation) was used as a polymer compound to be added to a solid electrolyte precursor.

Preparation of Solid Electrolyte Precursor

A solid electrolyte precursor was prepared by uniformly mixing 1,3-dimethylimidazolium iodide (DMII), iodine I₂ and polyethylene glycol 200 in acetonitrile so as to be 8.19 wt. % of 1,3-dimethylimidazolium iodide (DMII), 4.2×10⁻⁷ wt. % of iodine I₂ and 4.38 wt. % of polyethylene glycol 200. Acetonitrile corresponded to 87.4 wt. %.

[Comparative Example 2]

A dye-sensitized solar cell was produced in the same manner as Example 1 except that a gelled electrolyte was used as an electrolytic solution.

Preparation of Gelled Electrolyte Precursor

A gelled electrolyte precursor was prepared by uniformly mixing 1,3-dimethylimidazolium iodide (DMII), iodine I₂, polyethylene oxide and propylene carbonate as a solvent in acetonitrile so as to be 8.19 wt. % of 1,3-dimethylimidazolium iodide (DMII), 4.2×10⁻⁷ wt. % of iodine I₂, 2.19 wt. % of polyethylene oxide and 2.19 wt. % of propylene carbonate as a solvent. Acetonitrile corresponded to 87.4 wt. %. Excess acetonitrile in the precursor was removed by heating the gelled electrolyte precursor at 100° C.

[Comparative Example 3]

A dye-sensitized solar cell was produced in the same manner as in Example 1 except that an electrolytic solution was used in place of a polymer compound existing in a solid state.

Preparation of Electrolytic Solution Precursor

An electrolytic solution precursor was prepared by uniformly mixing 1,3-dimethylimidazolium iodide (DMII), iodine I₂ and propylene carbonate as a solvent in acetonitrile so as to be 8.19 wt. % of 1,3-dimethylimidazolium iodide (DMII), 4.2×10⁻⁷ wt. % of iodine I₂ and 4.38 wt. % of propylene carbonate as a solvent. Acetonitrile corresponded to 87.4 wt. %. Excess acetonitrile was removed by heating the electrolytic solution precursor at 100° C.

[Cell Performance Evaluation]

<Case of Low Illuminance>

With respect to the dye-sensitized solar cells of Examples and Comparative Examples, a power generation amount and a current value were evaluated when irradiated with a white LED bulb in low illuminance (illuminance: 200 lux). The evaluation results are shown in Table 1.

TABLE 1

| | Power Generation Amount | Current Value |
|---|---|---|
| | (W/cm²) | (A/cm²) |
| Example 1 | 4.45 × 10⁻⁶ | 1.19 × 10⁻⁵ |
| Example 2 | 3.53 × 10⁻⁶ | 8.21 × 10⁻⁶ |
| Example 3 | 4.07 × 10⁻⁶ | 9.22 × 10⁻⁶ |
| Example 4 | 4.28 × 10⁻⁶ | 1.42 × 10⁻⁵ |
| Example 5 | 3.99 × 10⁻⁶ | 8.84 × 10⁻⁶ |
| Example 6 | 4.73 × 10⁻⁶ | 1.34 × 10⁻⁵ |
| Comp. Example 1 | 1.09 × 10⁻⁶ | 1.45 × 10⁻⁵ |
| Comp. Example 2 | 3.70 × 10⁻⁶ | 1.05 × 10⁻⁵ |
| Comp. Example 3 | 3.70 × 10⁻⁶ | 1.15 × 10⁻⁵ |

As shown in Table 1, the dye-sensitized solar cells 10 according to Examples of the present invention showed good power generation amount and good current value regardless of a polymer compound to be added to a solid electrolyte precursor. Further, as read from Examples 1, 4 and 5, the dye-sensitized solar cells 10 showed good power generation amount and good current value, even when molecular weight was varied under a condition that a polymer compound to be added to a solid electrolyte precursor was fixed to polyethylene glycol and polyethylene oxide. On the other hand, as shown in Comparative Example 1, when polyethylene glycol (molecular weight 200) in liquid state at ordinary temperature and pressure was used, a power generation amount and a current value decreased. Further, power generation amounts and current values of the dye-sensitized solar cells of Examples and Comparative Examples fell within equivalent level among the solid electrolyte (Example 1), the gelled electrolyte (Comparative Example 2) and the electrolytic solution (Comparative Example 3). That is, no decrease in cell performance was observed by not containing propylene carbonate as a solvent (Example 1).

<Case of Medium Illuminance>

With respect to the dye-sensitized solar cells of Examples and Comparative Examples, a power generation amount and a current value were evaluated when irradiated with a white LED bulb in medium illuminance (illuminance: 10,000 lux). The evaluation results are shown in Table 2.

TABLE 2

| | Power Generation Amount | Current Value |
|---|---|---|
| | (W/cm²) | (A/cm²) |
| Example 1 | 2.42 × 10⁻⁴ | 4.81 × 10⁻⁴ |
| Example 2 | 1.38 × 10⁻⁴ | 2.11 × 10⁻⁴ |
| Example 3 | 1.24 × 10⁻⁴ | 2.28 × 10⁻⁴ |
| Example 4 | 2.36 × 10⁻⁴ | 6.31 × 10⁻⁴ |
| Example 5 | 9.04 × 10⁻⁵ | 4.61 × 10⁻⁵ |
| Example 6 | 2.73 × 10⁻⁴ | 5.70 × 10⁻⁴ |
| Comp. Example 1 | 3.68 × 10⁻⁵ | 4.70 × 10⁻⁴ |

As shown in Table 2, even in a case of irradiation in medium illuminance, the dye-sensitized solar cells of Examples showed good power generation amount and good current value regardless of a polymer compound to be added to a solid electrolyte precursor. Further, as read from Examples 1, 4 and 5, the dye-sensitized solar cells 10 showed good power generation amount and good current value, even when molecular weight was varied under a condition that a polymer compound to be added to a solid electrolyte precursor was fixed to polyethylene glycol and polyethylene oxide. On the other hand, as shown in Comparative Example 1, when polyethylene glycol (molecular weight 200) in liquid state at ordinary temperature and pressure was used, a power generation amount and a current value decreased.

<Case of High Illuminance>

With respect to the dye-sensitized solar cells of Examples and Comparative Examples, a power generation amount and a current value were evaluated when irradiated with a pseudo sunlight in high illuminance (1 SUN, illuminance: 108,000 lux). The evaluation results are shown in Table 3.

TABLE 3

| | Power Generation Amount | Current Value |
|---|---|---|
| | (W/cm²) | (A/cm²) |
| Example 1 | 3.31 × 10⁻⁴ | 6.80 × 10⁻⁴ |
| Example 4 | 6.74 × 10⁻⁵ | 1.27 × 10⁻³ |
| Example 5 | 4.24 × 10⁻⁵ | 5.15 × 10⁻⁵ |
| Comp. Example 1 | 2.83 × 10⁻⁵ | 1.53 × 10⁻³ |

As shown in Table 3, in a case of irradiation in high illuminance, the dye-sensitized solar cells of Examples did not show a power generation amount and a current value correlated with the results of low illuminance and medium illuminance, when molecular weight was varied under a condition that a polymer compound to be added to a solid electrolyte precursor was fixed to polyethylene glycol and polyethylene oxide. This is presumably because the ratio of an electrolyte in a solid electrolyte does not match a range in high illuminance. On the other hand, as shown in Comparative Example 1, when polyethylene glycol (molecular weight 200) in liquid state at ordinary temperature and pressure was used, a power generation amount greatly decreased although a current value was high.

[Power Holding Ratio at 80° C.]

The dye-sensitized solar cells of Example 1, Comparative Example 2 and Comparative Example 3 were put into an 80° C. reliability test, and electric power with respect to 80° C. holding time was observed. The conditions were as follows.
Test conditions (temperature and humidity): 80° C., 0% RH
Measurement conditions (illuminance): white LED, 200 lux

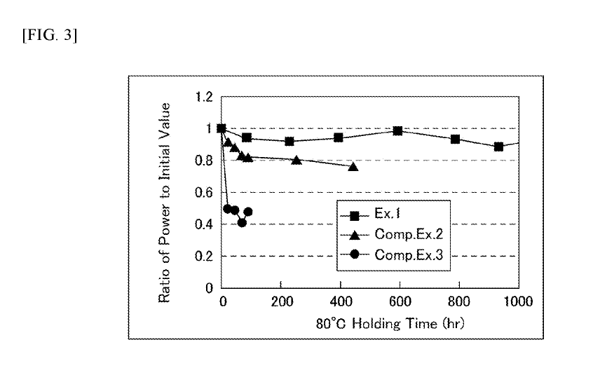

FIG. 3 shows a power ratio, namely a power holding ratio, with respect to 80° C. holding time with an initial electric energy of 1 representing. As shown in FIG. 3, in Example 1 with use of a solid electrolyte not containing an excessive solvent, the power holding ratio was above 0.9 (90%) even after 1,000 hours. On the other hand, in Comparative Example 2 with use of a gelled electrolyte containing propylene carbonate as a solvent, the power holding ratio was below 0.8 (80%) in about 400 hours, and in Comparative Example 3 with use of an electrolytic solution containing propylene carbonate as a solvent, the power holding ratio fell to about 0.5 (50%) after 20 hours.

### REFERENCE SIGNS LIST

10: dye-sensitized solar cell

11: electrode (negative electrode)

12: counter electrode (positive electrode)

13: oxide semiconductor particles

14: sensitizing dye

15: power generation layer

16: electrolyte layer

17: reverse electron transfer prevention layer

18, 19: Lead wire

20: ammeter

1. A dye-sensitized solar cell comprising:
an electrode;
a counter electrode disposed facing the electrode;
an electrolyte layer sandwiched between the electrode and the counter electrode; and
a power generation layer provided on a surface of a counter electrode side of the electrode and formed of oxide semiconductor particles supporting a sensitizing dye,
wherein the electrolyte layer includes a matrix, with an electrolyte dispersed therein, of a polymer compound existing in a solid state at ordinary temperature and pressure.

2. The dye-sensitized solar cell according to claim 1, wherein the polymer compound has in a main chain a constitutional unit including at least one selected from an oxygen atom, a sulfur atom, a nitrogen atom, a phosphorus atom, a fluorine atom and a silicon atom.

3. The dye-sensitized solar cell according to claim 2, wherein the polymer compound is at least one selected from polyethylene oxide, polyethylene glycol, polyvinyl alcohol, and polyvinylpyrrolidone.

4. The dye-sensitized solar cell according to claim 1, wherein the polymer compound has a substituent.

5. The dye-sensitized solar cell according to claim 4, wherein the substituent is at least one selected from a hydroxyl group, a carboxyl group, a carbonyl group, an ester group, an ether group, an amino group, an alkylamino group and an amide group.

6. The dye-sensitized solar cell according to claim 1, wherein the polymer compound has a weight-average molecular weight of more than or equal to 2,000.

7. The dye-sensitized solar cell according to claim 1, further comprising a reverse electron transfer preventing layer between the electrode and the power generation layer, the reverse electron transfer preventing layer having a film structure denser than the power generation layer.

8. The dye-sensitized solar cell according to claim 1, wherein the reverse electron transfer preventing layer has a thickness of more than or equal to 1 nm and less than or equal to 1 μm.

9. The dye-sensitized solar cell according to claim 1, wherein the electrolyte comprises triiodide ions I₃⁻ and iodide ions I⁻, a concentration of the iodide ions I⁻ being more than or equal to 1 mol/L and less than or equal to 10 mol/L, and moreover, more than or equal to 2 million times and less than or equal to 200 million times with respect to a concentration of the triiodide ions I₃⁻.

10. The dye-sensitized solar cell according to claim 1, which is applicable for use in indoor.

11. The dye-sensitized solar cell according to claim 2, wherein the polymer compound has a substituent.

12. The dye-sensitized solar cell according to claim 11, wherein the substituent is at least one selected from a hydroxyl group, a carboxyl group, a carbonyl group, an ester group, an ether group, an amino group, an alkylamino group and an amide group.

13. The dye-sensitized solar cell according to claim 2, wherein the electrolyte comprises triiodide ions I₃⁻ and iodide ions I⁻, a concentration of the iodide ions I⁻ being more than or equal to 1 mol/L and less than or equal to 10 mol/L, and moreover, more than or equal to 2 million times and less than or equal to 200 million times with respect to a concentration of the triiodide ions I₃⁻.

14. The dye-sensitized solar cell according to claim 3, wherein the electrolyte comprises triiodide ions I₃⁻ and iodide ions I⁻, a concentration of the iodide ions I⁻ being more than or equal to 1 mol/L and less than or equal to 10 mol/L, and moreover, more than or equal to 2 million times and less than or equal to 200 million times with respect to a concentration of the triiodide ions I₃⁻.

15. The dye-sensitized solar cell according to claim 4, wherein the electrolyte comprises triiodide ions I₃⁻ and iodide ions I⁻, a concentration of the iodide ions I⁻ being more than or equal to 1 mol/L and less than or equal to 10 mol/L, and moreover, more than or equal to 2 million times and less than or equal to 200 million times with respect to a concentration of the triiodide ions I₃⁻.

16. The dye-sensitized solar cell according to claim 5, wherein the electrolyte comprises triiodide ions I₃⁻ and iodide ions I⁻, a concentration of the iodide ions I⁻ being more than or equal to 1 mol/L and less than or equal to 10 mol/L, and moreover, more than or equal to 2 million times and less than or equal to 200 million times with respect to a concentration of the triiodide ions I₃⁻.

17. The dye-sensitized solar cell according to claim 6, wherein the electrolyte comprises triiodide ions I₃⁻ and iodide ions I⁻, a concentration of the iodide ions I⁻ being more than or equal to 1 mol/L and less than or equal to 10 mol/L, and moreover, more than or equal to 2 million times and less than or equal to 200 million times with respect to a concentration of the triiodide ions I₃⁻.

18. The dye-sensitized solar cell according to claim 7, wherein the electrolyte comprises triiodide ions I₃⁻ and iodide ions I⁻, a concentration of the iodide ions I⁻ being more than or equal to 1 mol/L and less than or equal to 10 mol/L, and moreover, more than or equal to 2 million times and less than or equal to 200 million times with respect to a concentration of the triiodide ions I₃⁻.

19. The dye-sensitized solar cell according to claim 8, wherein the electrolyte comprises triiodide ions I₃⁻ and iodide ions I⁻, a concentration of the iodide ions I⁻ being more than or equal to 1 mol/L and less than or equal to 10 mol/L, and moreover, more than or equal to 2 million times and less than or equal to 200 million times with respect to a concentration of the triiodide ions I₃⁻.

20. The dye-sensitized solar cell according to claim 10, wherein the electrolyte comprises triiodide ions I₃⁻ and iodide ions I⁻, a concentration of the iodide ions I⁻ being more than or equal to 1 mol/L and less than or equal to 10 mol/L, and moreover, more than or equal to 2 million times and less than or equal to 200 million times with respect to a concentration of the triiodide ions I₃⁻.
